(19) United States
(12) Patent Application Publication
(10) Pub. No.: US 2015/0344082 A1
(43) Pub. Date: Dec. 3, 2015

(54) TRUCK BED GAP COVER

(71) Applicant: Peter John Keklak, Cape Coral, FL (US)

(72) Inventor: Peter John Keklak, Cape Coral, FL (US)

(21) Appl. No.: 14/293,906

(22) Filed: Jun. 2, 2014

(51) Int. Cl. B62D 33/027; B60R 13/00

(52) U.S. Cl. CPC B62D 33/0273; B60R 13/00

(57) ABSTRACT

A truck bed gap cover covers a bed gap between a truck bed and a bed gate, and can include a first end flushly attached to a bed floor of the truck bed; a second end that extends from the first end and towards the bed gate; an optional hinge cover; and a hinge portion, attached to and between the first and second ends, and that hinges between a secured position and an active position. When the bed gate is open, the hinge portion is in the active position with the gap cover extending from the truck bed and over the bed gap, and when the bed gate is closed, the hinge portion is in the secured position with the hinge portion hinging upwardly with the second end extending upwardly with the bed gate. The hinge portion can be disposed above and/or adjacent to the bed gap. The first and second portions can be formed of a rigid material.

### RELATED DOCUMENTS

This document is related to, claims the priority benefit of, and incorporates by reference in its entirety, U.S. Provisional Patent Application Ser. No. 61/917,392 filed on Dec. 18, 2013 by Peter John Keklak.

### FIELD OF THE INVENTION

The present invention relates to truck beds, and more particularly, to truck bed accessories.

### BACKGROUND OF THE INVENTION

A truck bed includes the floor or bottom of a truck or trailer, and is commonly provided with sides and a gate configured to pivot between open and closed positions. When in a closed position, a bed gate can abut the truck bed and lock in an orientation perpendicular to the truck bed. When in an open position, a bed gate can hinge downwardly so as to be parallel with a truck bed, which leaves a gap between the truck bed and bed gate.

### SUMMARY OF THE INVENTION

It is an object of the present invention to provide a truck bed gap cover.

It is another object of the present invention to provide a truck bed gap cover that covers a bed gap between a truck bed and a bed gate.

In an exemplary embodiment of the present invention, a truck bed gap cover, which covers a bed gap between a truck bed and a bed gate, can include a first end that can flushly attach to the truck bed; a second end that can extend from the first end and towards the bed gate; and a hinge portion, that can attach to and between the first and second ends, and that can hinge between a secured position and an active position. When the bed gate is open, the hinge portion can be in the active position, such that the gap cover extends from the truck bed and over the bed gap, and when the bed gate is closed, the hinge portion can be in the secured position, such that the hinge portion hinges upwardly with the second end extending upwardly with the bed gate.

In another exemplary aspect of the present invention, the hinge portion can be disposed above and/or adjacent to the bed gap.

In another exemplary aspect of the present invention, the first and/or second portions can be formed of a rigid material, such as aluminum, for example and not in limitation.

In a further exemplary aspect of the present invention, a truck bed gap cover can further include a hinge cover attached to the truck bed gap cover, and disposed over the hinge portion.

In yet another exemplary aspect of the present invention, at least one of the first portion, the second portion, and the hinge portion can include a flexible material.

### BRIEF DESCRIPTION OF THE DRAWINGS

FIG. 1 illustrates an exemplary prior art truck bed.

FIG. 2a illustrates, from a side-view perspective, an exemplary embodiment of the present invention prior to installation.

FIG. 2b illustrates, from a side-view perspective, an exemplary embodiment of the present invention during installation.

FIG. 3a illustrates, from a top-down perspective, an exemplary environment of the present invention.

FIG. 3b illustrates, from a top-down perspective, an exemplary embodiment of the present invention combined with an exemplary truck bed.

FIG. 3c illustrates, from a top-down perspective, another exemplary embodiment of the present invention combined with an exemplary truck bed.

FIG. 4a illustrates, from a side-view perspective, an exemplary embodiment of the present invention in a secured position.

FIG. 4b illustrates, from a side-view perspective, an exemplary embodiment of the present invention in an active position.

FIG. 5a illustrates exemplary truck bed gap cover, in an open position, and with an option hinge cover.

FIG. 5b illustrates exemplary truck bed gap cover, in an closed position, and with an option hinge cover.

FIG. 6a illustrates exemplary truck bed gap cover, in an open position, and configured with a truck bed having a bed liner.

FIG. 6b illustrates exemplary truck bed gap cover, in a closed position, and configured with a truck bed having a bed liner.

### DETAILED DESCRIPTION

It is an object of the present invention to provide a truck bed gap cover having a plurality of embodiments, which are described, and are to be broadly interpreted, via the disclosure herein.

It should be noted that this disclosure includes a plurality of elements and/or aspects, and such elements and/or aspects need not necessarily be interpreted as being conjunctively required by one or more embodiments of the present invention. Rather, all combinations of the one or more elements and/or aspects can enable a separate embodiment of the present invention, which may be claimed with particularity in this or in one or more future filed Non-Provisional Patent Applications. Moreover, any particular materials, structures, and/or sizes disclosed herein, whether expressly or implicitly, are to be construed strictly as illustrative and enabling, and not necessarily limiting. Therefore, it is expressly set forth that such materials, structures, and/or sizes independently or in any combination of one of more thereof, are merely illustratively representative of one or more embodiments of the present invention and are not to be construed as necessary in a strict sense.

Further, to the extent the same element or limitation is defined differently anywhere within this disclosure, whether expressly or implicitly, the broader definition is to take absolute precedence, with the distinctions encompassed by the narrower definition to be strictly construed as optional.

Illustratively, perceived benefits of the present invention can include functional utility, including those of a decorative nature, and whether expressly or implicitly stated herein or apparent herefrom. However, it is expressly set forth that these benefits are not intended as exclusive. Therefore, any explicit, implicit, or apparent benefit from the disclosure herein is expressly deemed applicable to the present invention.

When a bed gate is in an open position, a bed gap can exist between the bed gate and the truck bed. In one aspect, such a gap can allow debris and other small items to fall therein, which can prevent the bed gate from thereafter closing and/or allow such debris or small items to fall therethrough and to the ground. In another aspect, such a gap can inhibit a wheel from passing thereover, as such a wheel can lodge therein.

The present invention provides a truck bed gap cover that can minimize or overcome one or both of the problems above.

In an exemplary embodiment of the present invention, a truck bed gap cover can be configured to cover a bed gap between a truck bed and a bed gate. In one embodiment, such a gap cover can cover the bed gap when a bed gate is in an open position, such that debris or small items cannot fall into, or through, the bed gap. In another exemplary embodiment, such a gap cover can include a rigid portion that extends over the bed gap, bridging the truck bed and bed gate, which can allow one or more wheels to roll thereover without lodging therein.

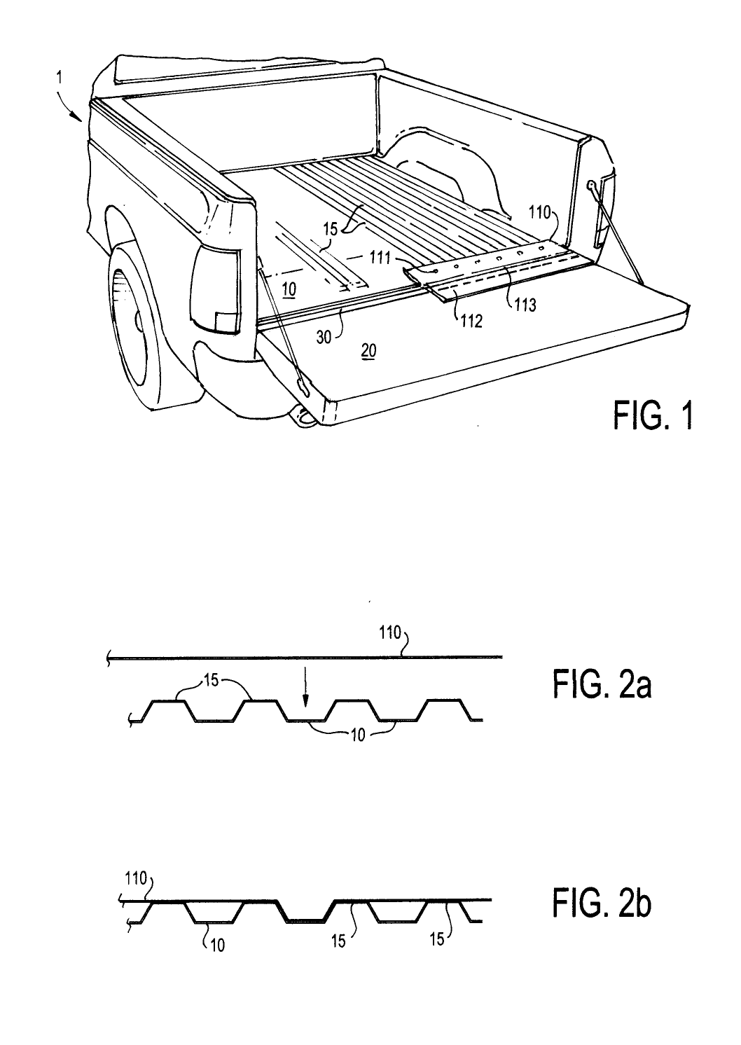

FIG. 1 illustrates an exemplary prior art truck bed 1 having a bed floor 10, optional bed guides 15, a bed gate 20, and a bed gap 30 between the truck bed and bed gate.

According to an exemplary embodiment of the present invention, a truck bed gap cover 110 can be configured to cover a bed gap 30 between a truck bed 1 and a bed gate 20, with the truck bed gap cover having a first end 111, having a thickness of less than 0.5 inches, and being configured to attach to the truck bed in a flush manner; a second end 112; and a flexible portion 113, disposed between said first and second ends, and configured to flex between a secured position and an active position. Accordingly, when bed gate 20 is open, flexible portion 113 can be in the active position, such that gap cover 110 extends from truck bed 1 and over bed gap 30; and when the bed gate is closed, the flexible portion can be in the secured position, such that the flexible portion flexes upwardly with second end 112 extending upwardly with bed gate 20.

FIG. 2a illustrates, from a side-view perspective, an exemplary embodiment of the present invention prior to installation. As illustrated, prior to installation, a gap cover 110 can be disposed over a bed floor 10 and optional bed guides 15. FIG. 2a illustrates, from a side-view perspective, that gap cover 110 can be pressed or otherwise deformed (including melting via a heat source, such as a heat gun, for example and not in limitation) to fit flushly against bed floor 10, and if present, against bed guides 15. Notably, FIG. 2b illustrates such flush attaching between two bed guides 15, however, such pressing or deforming can be insofar as required or desired. Also notably, gap cover 110 can alternatively be provided in a pre-formed manner, such that any pressing or deformation thereof is obviated. Further notably, insofar as bed guides 15 are not present or do not extend to the terminal edge of truck bed 1, thus leaving a flat portion of bed floor 10, gap cover 110 can be attached to such a flat portion. According to the present invention, gap cover 110 can be attached to bed floor 10 in any desired manner that is functionally consistent with the present invention, such as via nails, screws, magnets, adhesive, etc., for example and not in limitation. Further, attachment can be effectuated by static friction, where gap cover 110 is placed under a bed-liner, or attached otherwise under a bed-liner. Also, gap cover 110 can optionally include an attachment strip (not shown) formed of a durable material (metal, plastic, rubber, man-made or naturally-occurring material, etc.) that can be attached to bed floor 10 to facilitate a stronger attachment of gap cover 110. Such a strip can be a separate piece or integral with gap cover 110. For example, such a strip can be attached over gap cover 110, such that one or more screws can pass through such a strip and then through gap cover 110.

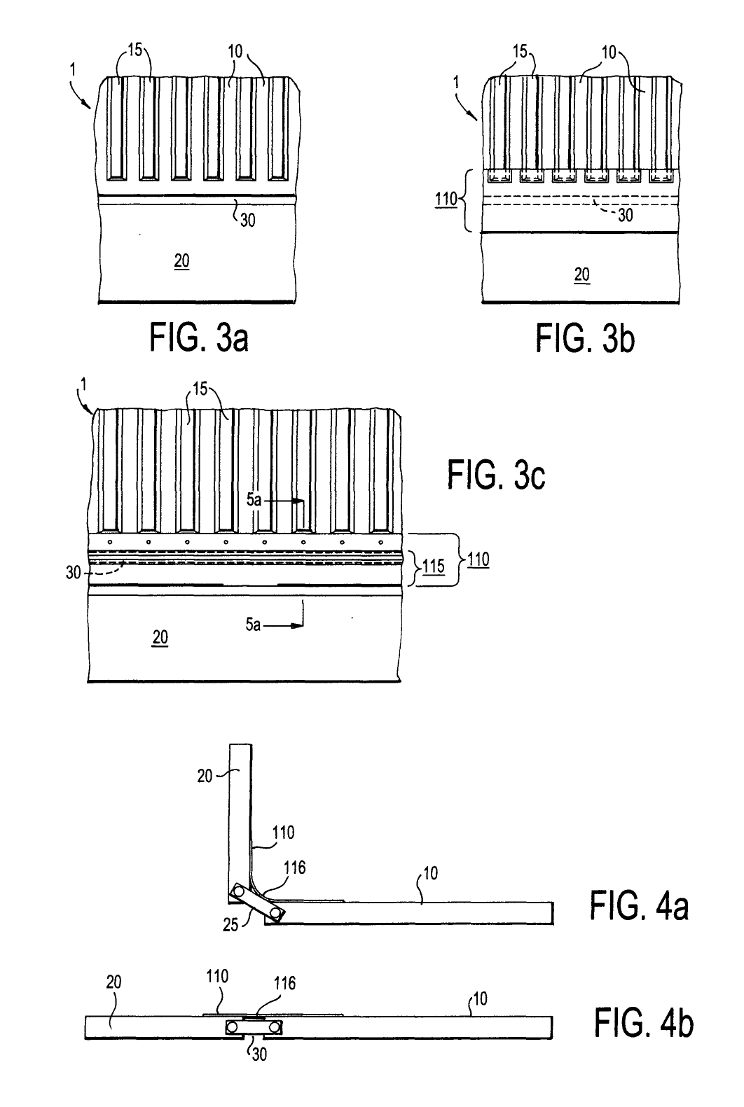

FIG. 3a illustrates, from a top-down perspective, an exemplary truck bed 1 having a bed floor 10, optional bed guides 15, bed gate 20, and bed gap 30, prior to application of the present invention.

FIG. 3b illustrates, from a top-down perspective, such an exemplary truck bed after installation of an exemplary embodiment of the present invention. As illustrated, once attached, exemplary gap cover 110 can cover bed gap 30 when bed gate 20 is in an open position. Thus, debris and other small items (not shown) within truck bed 1 cannot fall within the bed gap 30.

FIG. 3c illustrates, from a top-down perspective, such an exemplary truck bed 1 after installation of another exemplary embodiment of the present invention. As illustrated, once attached, exemplary gap cover 110, which can optionally include a rigid portion 115, covers bed gap 30 when bed gate 20 is in an open position. Further, as illustrated, rigid portion 115 can bridge bed floor 10 and bed gate 20, such that the rigid portion can prevent a wheel or other heavy item from lodging within bed gap 30.

In an exemplary aspect of the present invention, gap cover 110 can be formed from any one or more desired materials that are functionally compatible with the present invention as described, such as, for example and not in limitation, any one or more of a plastic, rubber, metal, sheet metal, flexible sheet metal, any naturally occurring, or any man-made material. Notably, rigid portion 115, insofar as optionally provided, can be attached to the top or bottom of gap cover 110, encased thereby, formed therein, or can be integral therewith. In another example, gap cover 110 can be formed, in whole or in part, of a highly rigid material, such as steel, such that rigid portion 115 is integral therewith. Further, gap cover 110 can be provided in any thickness desired, insofar as the same is functionally compatible with the present invention. In one exemplary embodiment, such thickness can be less than 0.5 inches at least where gap cover 110 attaches to bed floor 10, to allow debris and other items within truck bed 1 to be swept or otherwise removed across the cover and from the truck bed 1.

FIG. 4a illustrates, from another side view perspective, an exemplary gap cover 110 with bed gate 20 in a closed position. As illustrated, bed gate 20 can be moveably engaged with bed floor 10 via a gate hinge 25, which allows the bed gate to move between open and closed positions. As further illustrated, gap cover 110 can include a flexible portion 116 that can flex upwardly with at least a portion of gap cover 110 extending upwardly with bed gate 20.

FIG. 4b illustrates, from a side view perspective, an exemplary gap cover 110 with bed gate 20 in an open position. As illustrated, when bed gate 20 is moved from the closed position to the open position, flexible portion 116 can change to an active position, in which gap cover 110 can extend from bed floor 10 and over bed gap 30. Notably, flexible portion 116 can move between positions via material selection (for example, and not in limitation, a rubber with or without having a memory), or via additional structure (for example, and not limitation, a hinge, which can optionally be biased towards the active position via gravity or a spring). Also notably, gap cover 110 can be movably attached to bed gate 20, such as via an elastic element or a slotted washer, to accommodate movement thereof between opening and closing of bed gate 20. Notably, flexible portion 116 can be provided exclusively above bed floor 10 to accommodate incorporation of a rigid portion 115 that bridges truck bed 10 and bed gate 20.

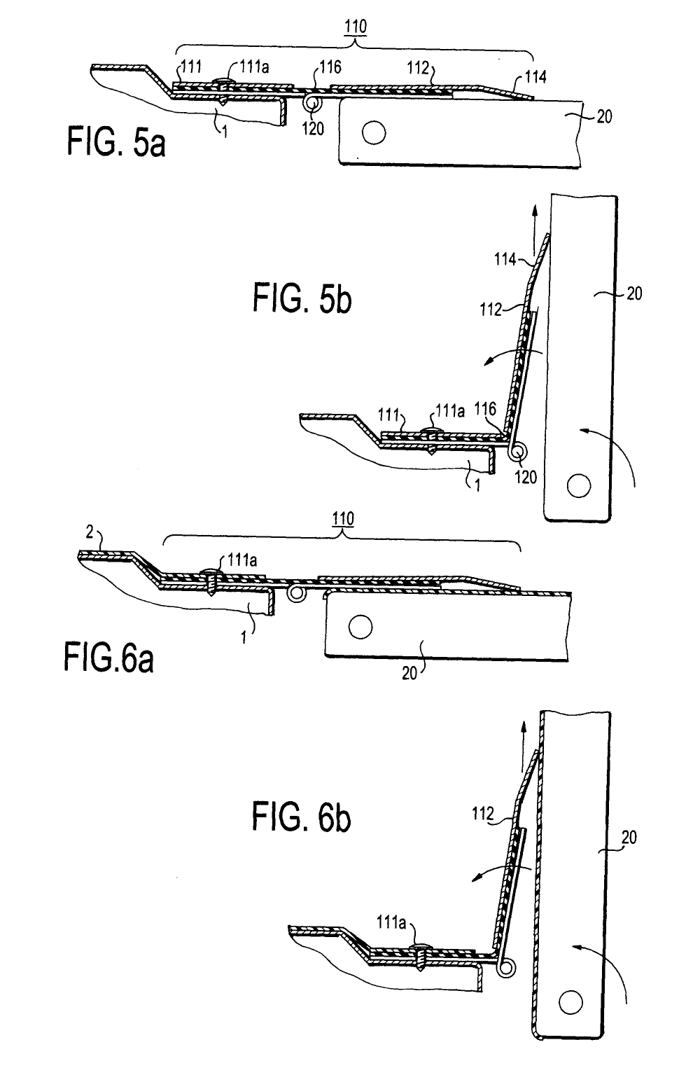

FIGS. 5a and 5b illustrate another exemplary embodiment of the present invention, in which FIG. 5a illustrates a gap cover 110 in an open position and FIG. 5b illustrates the gap cover is a closed position.

In this exemplary embodiment, a gap cover 110 can include a first end 111 and a second end 112 attached to each other via a hinge 120. Notably, hinge 120 can be attached to the bottoms (as illustrated) or tops of first and second ends 111, 112. Further, any type of functionally compatible hinge structure, in whole or in part, can be utilized with the present invention, and thus, is expressly not limited to the specific hinge illustratively shown. For example, any one or more of the following hinge technologies, in whole or in part, can be utilized with the present invention: a barrel hinge, a pivot hinge, a butt hinge, a mortise hinge, a case hinge, a continuous hinge, a piano hinge, a concealed hinge, a butterfly hinge, a parliament hinge, a flag hinge, a strap hinge, an HL hinge, a counterflap hinge, a flush hinge, a coach hinge, a rising butt hinge, a double action spring hinge, a tee hinge, a friction hinge, a security hinge, a cranked hinge, a stormproof hinge, a lift-off hinge, a self-closing hinge, and a spring hinge, insofar as functionally compatible with the present invention as described.

As illustrated, first end 111 can be fixed to truck bed 1, which can be effectuated in any functionally compatible manner, such as via a screw 111a, or a rivet, adhesive, magnet, etc. Further, as illustrated in FIG. 5a, when gap cover 110 is in an open position, second end 112 can extend over bed gate 20, which can prevent debris from falling within bed gap 30 and provide a bridge to allow items to be rolled or moved thereover. As also illustrated, gap cover 110 can optionally include a hinge cover 116, which can be disposed over hinge 120. Hinge cover 116 can be formed of a flexible material, such as a rubber or plastic or any other functionally compatible material, and can protectively cover hinge 120 from debris interfering with operation of the hinge and damage to the hinge from items rolling or otherwise moving there against. As further illustrated in FIG. 5a, second end 112, which can be provided in a generally linear configuration, can optionally include a downwardly angled portion 114 to accommodate bed gate 20 being slightly higher than truck bed 1 when in an open position. It should be noted that first and second ends 111, 112 are illustratively shown as separate elements from hinge 120; however, one or both ends 111, 112 can be integral with the hinge to the extent desired, and notably, can provide a single structural plane if so desired.

FIG. 5b illustrates gap cover 110 in an exemplary closed position, in which second end 112 can transition from a horizontal configuration when bed gate 20 is in an open position to an upwardly angled position when bed gate 20 is in a closed position.

FIGS. 6a and 6b illustrate another exemplary application of the present invention, in which a gap cover 110 can be integrated with a truck bed 1 having a bed liner 2. As illustrated, first end 111 can be disposed between truck bed 1 and bed liner 2, which can frictionally hold the first end in place without the need of a fixing or attaching structure, such as a screw 111a, or a rivet, adhesive, magnet, etc., which can nonetheless be optionally utilized insofar as desired. Notably, first end 111 can alternatively be attached over bed liner 2, with attachment thereto being in any functionally compatible manner, such as via a screw 111a, or a rivet, adhesive, magnet, etc. FIG. 6b illustrates gap cover 110 in an exemplary closed position, in which second end 112 can transition from a horizontal configuration when bed gate 20 is in an open position to an upwardly angled position when bed gate 20 is in a closed position.

It should be further noted that hinge 120 is exemplarily shown as facing upwardly, however, the present invention contemplates that the same can be facing downwardly to the extent desired and to the extent functionally compatible with the present invention as described. Further, hinge 120 is exemplary shown as being disposed above bed gap 30; however, insofar as desired and functionally compatible with the present invention, the hinge can be disposed adjacent to the bed gap, whether above bed floor 10 or bed gate 20.

It will be apparent to one of ordinary skill in the art that the manner of making and using the claimed invention has been adequately disclosed in the above-written description of the exemplary embodiments and aspects.

It should be understood, however, that the invention is not necessarily limited to the specific embodiments, aspects, arrangement, and components shown and described above, but may be susceptible to numerous variations within the scope of the invention.

Therefore, the specification and drawings are to be regarded in an illustrative and enabling, rather than a restrictive, sense.

Accordingly, it will be understood that the above description of the embodiments of the present invention are susceptible to various modifications, changes, and adaptations, and the same are intended to be comprehended within the meaning and range of equivalents of the appended claims.

Therefore, I claim:

1. A truck bed gap cover covering a bed gap between a truck bed and a bed gate, said truck bed gap cover comprising:
a first end flushly attached to a bed floor of the truck bed;
a second end that extends from said first end and towards the bed gate; and
a hinge portion, attached to and between said first and second ends, and that hinges between a secured position and an active position;
wherein when the bed gate is open, said hinge portion is in the active position, such that the gap cover extends from the truck bed and over the bed gap, and when the bed gate is closed, said hinge portion is in the secured position, such that the hinge portion hinges upwardly with said second end extending upwardly with the bed gate.

2. The truck bed gap cover of claim 1, wherein said hinge portion is disposed above the bed gap.

3. The truck bed gap cover of claim 1, wherein said hinge portion is disposed adjacent to the bed gap.

4. The truck bed gap cover of claim 1, wherein said first and second portions are formed of a rigid material.

5. The truck bed gap cover of claim 4, wherein the rigid material is aluminum.

6. The truck bed gap cover of claim 1, further comprising a hinge cover attached to the truck bed gap cover, and disposed over said hinge portion.

7. The truck bed gap cover of claim 1, wherein at least one of said first portion, said second portion, and said hinge portion include a flexible material.
